(19) United States
(12) Patent Application Publication
(10) Pub. No.: US 2021/0256944 A1
(43) Pub. Date: Aug. 19, 2021

(54) Handheld Polyphonic Musical Wind Instrument

(71) Applicant: Samuel Jewell Lochner, Kitchener (CA)

(72) Inventor: Samuel Jewell Lochner, Kitchener (CA)

(21) Appl. No.: 16/866,872

(22) Filed: May 5, 2020

Related U.S. Application Data
(60) Provisional application No. 62/977,201, filed on Feb. 15, 2020.

(51) Int. Cl. G10D 7/16; G10D 9/035; G10H 1/00; G10H 1/34

(52) U.S. Cl. CPC G10D 7/16; G10D 9/035; G10H 1/0066; G10H 2230/365; G10H 1/344; G10H 2220/361; G10H 2220/221; G10H 1/0008

(57) ABSTRACT

A handheld polyphonic free reed and electronic musical wind instrument that has ergonomic advantages over similar instruments. Multiple parallel rows of keys each an octave apart allow for sufficient range for most melodies and chord progressions while the hands remain stationary on the instrument and the fingers of both hands work in unison. The keyboard is separated into groups of keys intended for the left and right hands.

### FIELD OF THE INVENTION

The current invention described herein relates to musical instruments. More specifically, it relates to handheld polyphonic keyed free reed musical wind instruments as well as electronic versions of such instruments.

### BACKGROUND

The piano is possibly the most popular instrument of all time. The sequential layout of the keys makes it easy for beginners to understand. And experts appreciate the opportunity to simultaneously use all the fingers and thumbs of both hands as this permits for playing not just single note melodies but also accompaniments and even complete musical pieces of considerable complexity. And the sound of a piano is greatly appreciated across a wide range of musical genres and styles. Nevertheless, the piano does have shortcomings, and so may not be the optimal instrument in all scenarios. Firstly, it lacks portability and is not handheld. Secondly, it does not permit the same kind of expression possible with instruments powered by the breath. Third, human fingers are not as well suited to striking keys as say the wrist and arms for striking strings on a guitar, and so the piano is not as useful as a rhythmic accompaniment instrument.

Instruments powered by the breath, such as those employing beating reeds, like the saxophone, are better for the first two considerations but not the third (they tend to be monophonic, meaning only one note can be played at a time). Wind instruments employing free reeds are also better for the first too considerations but additionally improve on the third consideration; they are often polyphonic and articulation of the highly dexterous tongue can be used to strike chords rhythmically. Free reeds are thin strips of material fixed to a frame that vibrate as air travels past them to produce sound.

The most popular free reed instrument is the harmonica. It offers unparalleled capability for its small size and weight. However, it is limited in that, without special playing techniques, only adjacent notes for adjacent blow/draw holes can be sounded simultaneously, limiting its usefulness for playing complex multi-note pieces. Another popular free reed instrument, the accordion, on the other hand, does not have this limitation. But it is a significantly larger instrument and does not make use of the breath. The compromise is a melodica, which is smaller than an accordion but is more complete as a breath powered polyphonic instrument than a harmonica. The current invention is most like the melodica.

Similar instruments to the melodica were devised as early as the beginning of the 19th century. But it wasn't until 1962 that Lindermeier Franz patented the “Mouthpiece operated wind musical instrument with piano keyboard” under the assignee “HOHNER INC M”, which lead to the melodica. The many unique features explained in the patent paved the way to an inexpensive and versatile instrument. It is now manufactured by various companies under different names, such as the melodion by Suzuki.

In a melodica, the musician blows into a mouthpiece connected directly or via a tube to the instrument, pressurizing a chamber. When a key, from a set sequentially arranged like those in a piano, is depressed, air is permitted to exit this chamber by way of passing a free reed, causing the reed to sound (it vibrates and so does the departing air, thereby producing sound). A resonating chamber further amplifies and adjusts the sound. Multiple reeds can be sounded simultaneously by pressing multiple keys, making it a polyphonic instrument.

The main deficiencies of the melodica are of an ergonomic nature. The layout of keys borrowed from a piano was not originally intended to be played perpendicular to the body and with one hand while the instrument is supported with the other. The supporting hand cannot contribute towards playing the keys. And repositioning of the playing hand may be inexact, particularly because visibility of the keys is poor, unlike on a piano.

Some melodicas have sharp/flat keys intended to be played by the left hand, allowing the fingers of both hands to work simultaneously as the instrument is supported by the thumbs. This does help for certain scenarios, like playing complex chords. However, musical pieces usually span multiple octaves, and so the hands need to be frequently repositioned, which is difficult when they are needed to support the instrument.

An alternative approach to playing a melodica is to lay it on a surface and breathe into the chamber via a hose, freeing up both hands to play it. But then it is no longer a handheld instrument. Another area for improvement is the size and shape of the melodica; its length limits its portability.

These deficiencies are perhaps the reason why the melodica has not reached the same level of popularity as the smaller but less versatile harmonica or the larger but more versatile accordion. The current invention is similar to a melodica but with these deficiencies addressed.

Various other instruments share elements of accordions, harmonicas, and melodicas, and each comes close to being an ergonomically satisfactory handheld polyphonic keyed free reed musical wind instrument, such as the harmonetta, couesnophone, hermonetta, accordina. However, the current invention has essential novel elements that make it, in some ways, ergonomically superior to all of these instruments.

The current invention represents a novel and ergonomically satisfactory way of using the breath and fingers of both hands to play a polyphonic keyed musical wind instrument. As such, this patent covers both the free reed instance of the instrument and all other derivations, including electronic, digital, synthesizer, MIDI, and software emulators.

### BRIEF SUMMARY OF THE INVENTION

The current invention is an ergonomic polyphonic keyed handheld musical wind instrument with one version that produces sound through the vibration of free reeds and another version that produces sound electronically.

The keyboard consists of two or more parallel rows of keys, each being an octave apart. These may be broken into groups of keys intended for the left hand and groups of keys intended for the right hand, with additional keys potentially added, and arranged in various ways. In a single position, in the instance of two parallel rows of keys, the fingers of the left and right hands together cover a two octave range of notes, approximately. The left and right hands play designated groups of keys and work in unison to play chords and melodies. The minimal repositioning of the hands, coupled with the cooperative and specialized use of the fingers of both hands, leads to a highly ergonomic and portable polyphonic wind instrument.

The inner-workings of the instrument employ free reeds in a similar manner as a melodica to produce sound. Alternatively, the instrument takes the form of an electronic, digital, synthesizer, MIDI, or software emulated instrument to produce sound.

### BRIEF DESCRIPTION OF THE DRAWINGS

FIG. 1 shows a basic configuration of the instrument being held in a starting position.

FIG. 2 shows a view of the instrument being played similar to FIG. 1, except that one hand has been moved to a new group of keys such that the two hands together span a higher or lower pair of octaves of notes than in the starting position.

FIG. 3 shows how the keyboard can be broken into groups of keys intended for a given hand to better organize the keyboard.

FIG. 4 shows sample keyboard note layouts.

FIG. 5 shows how more than two parallel rows of keys (three in this case) can be used to allow the hands to cover more than two octaves in one position. Additionally, FIG. 5 shows how adjacent keys between parallel rows need not be arrange back-to-back as in FIGS. 1 through 4 but can be arranged front-to-back.

FIG. 6 shows the various ways air can be blown into the instrument including through a neck or through a tube, as well as various ways to support the instrument.

FIG. 7 is a sectional view taken along lines 7-7 of FIG. 1 showing how air travels through the instrument.

FIG. 8 is a depiction of the electronic version of the instrument.

FIG. 9 is a sagittal of view of a human head and electronic instrument mouthpiece showing a novel breath control system with two sensors to detect variation in airflow as guided by the tongue for the purpose of changing pitch or guiding direction of note strumming.

### DETAILED DESCRIPTION OF THE INVENTION

The current invention is an ergonomic handheld polyphonic keyed musical wind instrument including a version that produces sound via free reeds and another that produces sound electronically. The term ergonomic in this context is used to state that the instrument is more comfortable and convenient to play certain musical pieces in certain situations than similar instruments that have preceded it. The term handheld in this context means that it can be played while being held in the hands, though it may also be played in other ways. The term polyphonic in this context means that multiple notes can be sounded simultaneously. The term keyed in this context means that keys, or buttons (a word used interchangeably with the word ‘keys’ throughout this patent), are used to determine which notes will be played. The term wind in this context means that the movement of air, mainly via breath though possibly other means, causes the reeds to sound. The term free reed in this context means thin strips of material fixed to a surface that produce sound through vibration, much the same as in harmonicas and accordions. The term electronic in this context means sound will be produced electronically rather than through the vibration of free reeds and the types of electronic instruments include digital, MIDI, synthesizer, and software emulated.

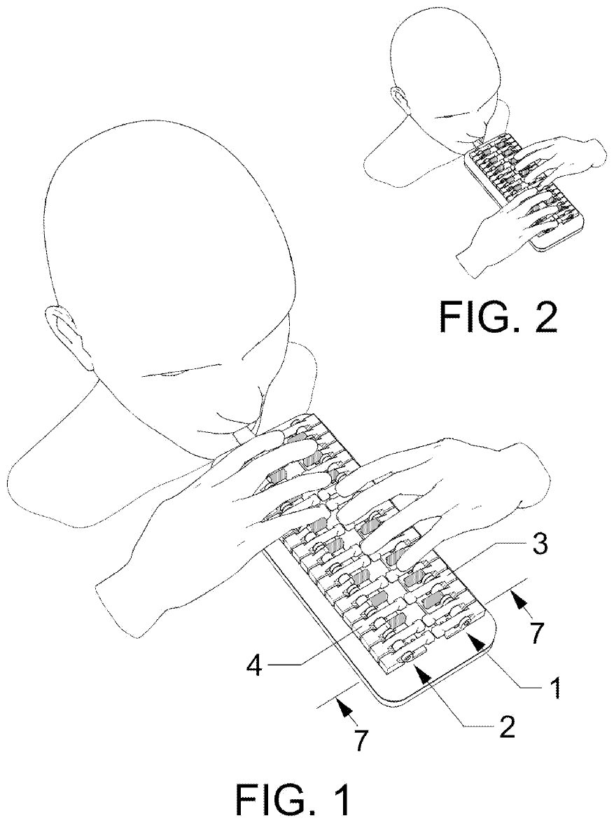

In the configuration of the invention that is most similar to a preceding instrument, the melodica, the main difference is that instead of a single sequential row of keys, there are two sequential rows of keys 1, 2, with each key in the first row 3 being for a note one octave apart by pitch as the note corresponding with adjacent key in the second row 4 as in FIG. 1. For instance, a key for C4 (fourth C on a piano also known as middle C) in the first row is directly beside the key for C5 in the second row. Adjacent keys between the two parallel rows are close enough together such that either can be reached with the same finger without repositioning the hand. Also covered by this patent are versions of the instrument having more than two parallel rows.

The benefit of having two parallel rows of keys one octave apart as opposed to a single row is that twice the pitch range is available in a single hand position, allowing for the playing of musical pieces requiring a greater pitch range without having to reposition the hands. And large chords require minimal reaching. Also beneficial is that the voicing of chords can be altered by simply moving a finger to the adjacent key in the parallel row. Furthermore, given hand position remains constant, the fingers of both hands can be utilized and they may also become specialized for playing specific notes, which may be advantageous for playing certain kinds of music.

The spacing between keys within a row for the current invention is similar to a conventional keyboard (though actually the same as some melodicas) such that the four fingers of one hand can reach approximately seven keys without the hand being repositioned. This number is useful because there are twelve keys per octave in the chromatic scale, plus one if the chromatic scale is to end on a note exactly one octave above the starting note, and so the fingers of both hands, when one hand is positioned immediately after the other, together can reach, without repositioning the hands, a full one octave chromatic scale with one key to spare (twice this when also considering the second parallel row of keys). More importantly, there are eight notes in a major or minor scale which is the same as the number of fingers, and it is convenient to be able to play a full scale with one finger per note without repositioning the hands.

If more range is required for a musical piece, the hand(s) can still be repositioned further along the instrument keyboard (FIG. 2). The intention with the current invention though is that the repositioning be in twelve semitone discrete jumps, unlike the continuous movements commonly used on conventional piano keyboards, such that the repositioned hand(s) now plays notes of the same letters but one octave higher by pitch. The fingers then maintain their specialization for playing particular keys and the hand(s) now may remain gripping the instrument in the new position, spanning a new dual chromatic octave of notes, until such time the musical piece requires a different pitch range. With this approach, minimal repositioning of the hands is required.

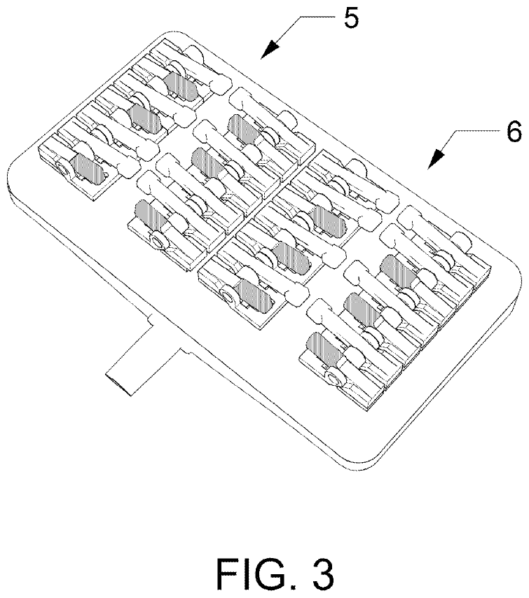

One drawback of the invention as described thus far is that the large number of densely spaced keys can be challenging to become familiar with. One solution covered in this patent is the separation of keys into groups. A gap may be left between groups of keys intended for the left and right hands 5, 6 and groups may be placed end-to-end or side-by-side (FIG. 3). Any relative position and angle between the groups may be used.

Groups of keys intended for the left hand consist of keys for half of a musical alphabet of notes including sharps and flats, approximately, while groups of keys intended for the right hand consist of keys for the remaining half of the same musical alphabet of notes including sharps and flats, approximately. For example, using the Latin musical alphabet system, groups of keys for the left hand may consist of the note letters A, B, C and D and sharps and flats while groups of keys for the right hand consist of note letters E, F, G, and A including sharps and flats. The repeated A is added to the groups for the right hand so that the eight fingers can play a complete eight note scale with each finger responsible for one note. Adjacent keys between parallel rows within groups are of the same note letter, just pitched an octave apart. In addition to the Latin musical alphabet system, any other musical alphabet system may be used.

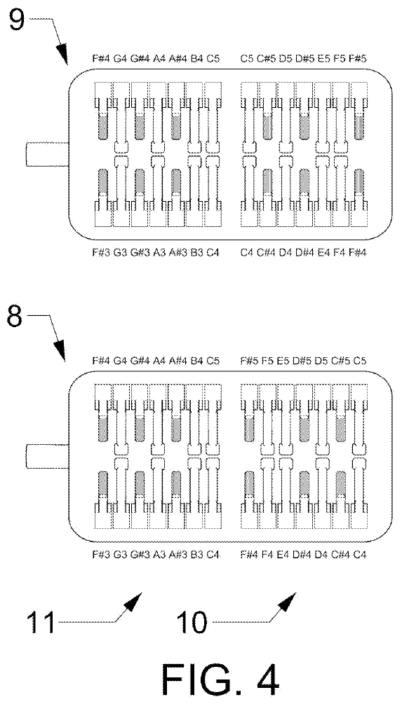

The pitch of the keys within groups may either descend or ascend from pinky finger to ring finger, and the direction may differ between groups intended for the left and right hands to suit the familiarities of a piano or wind instrument musician (FIG. 4). For instance, in one version of the instrument 8, pitch will ascend in the left hand from pinky finger to ring finger and then ascend from ring finger to pinky finger in the right hand in order to suit the familiarities of a piano player. In another version 9 of the instrument, pitch may descend from ring finger to pinky finger side for both groups of keys for the left and right hands.

The instrument may be built in various musical keys and voice ranges. For example, a tenor C version with two parallel rows of keys in each group and an overall range of two octaves (FIG. 4) would have keys, for the left hand 10, C4, D4, E4, F4 (number represents sequential position on a traditional 88-key piano keyboard) and sharps/flats on the first row of keys and C5, D5, E5, F5 and sharps/flats on the second row of keys.

The keys for the right hand 11 would then be G3, A3, B3, C4 and sharps/flats on the first row and G4, A4, B4, C5 and sharps/flats for the second row.

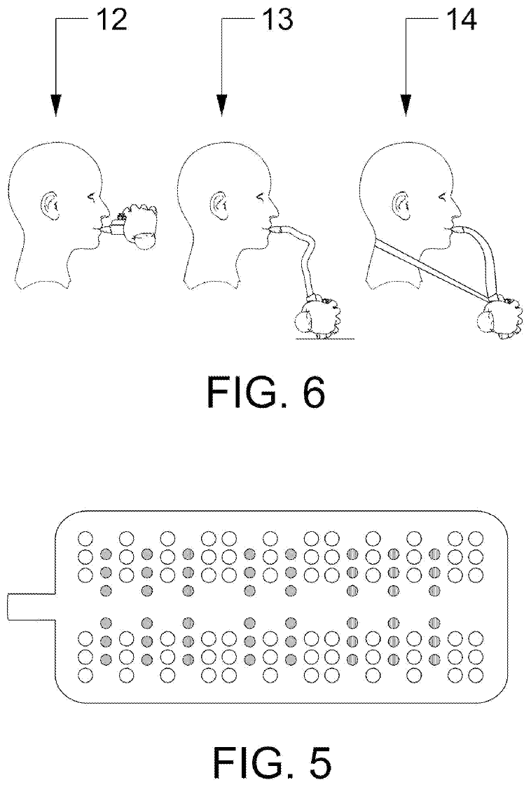

Adjacent keys between parallel rows may be mirror images of each other, either back-to-back or front-to-front. Back-to-back may be preferable (contact regions of white keys are closer to the mirror plane than the contact regions of the black keys) for ease of playing (FIG. 4), particularly octaves (keys for two notes one octave apart are simultaneously pressed). Alternatively, and particularly in the case of button keys and more than two parallel octaves, the keys may be arranged front-to-back (FIG. 5).

White keys (naturals) on a piano overlap the black keys (sharps/flats), creating a larger white key surface for the fingers to strike. This makes sense given white keys are played more commonly and at earlier stages in musical education. The keys of a melodica are arranged similarly. The downside to this overlapping is that the fingers need to stretch further to reach the black keys. This is fine for a single sequential row of keys as on a piano or melodica where the hand is regularly repositioned relative to the instrument. But for two or more parallel sequential rows and without regular repositioning of the hands, as is intended in the current invention, the additional necessity to reach with the fingers is problematic. Hence, in one configuration of the current invention, the white keys do not overlap the black keys (FIG. 4). But the keys of the current invention, in some configurations, still share other characteristics with those of pianos and melodicas. Specifically, the white keys are still longer and with a larger contact region than the black keys, while the black keys are raised.

There are three configurations for the connection of the mouthpiece in the current invention (FIG. 6). In the first 12, the mouthpiece belongs to or mounts directly into the instrument. In the second configuration 13, the mouthpiece belongs to or mounts into a flexible air hose that connects to the instrument. In the third configuration 14, the instrument has a neck extending beyond the playing region, and the mouthpiece belongs to or mounts into this. A single instrument may be able to accommodate all three of these possibilities as in a modular system.

The invention may be supported in various ways (FIG. 6). It may be supported by the thumbs, the palms, the musician's lips or teeth on the mouthpiece (the mouthpiece may have a ridge so it does not slip out of the mouth), any part(s) of the body, a solid object(s), or straps for the neck, wrist, hands, or thumbs. The invention may be supported by any combination of these possible supports.

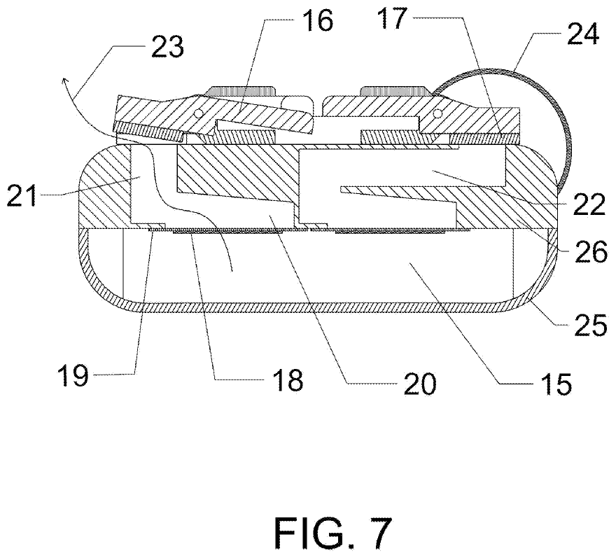

In the version of the invention that employs vibrating reeds to produce sound, air enters a mouthpiece and passes into a chamber 15 formed by the chamber body 25 and bottom of the reed pan 26, pressuring the chamber (FIG. 7). When a key 16 is pressed, a pad 17 is lifted, permitting air to travel past a free reed 18 which is affixed a reed plate 19 which is in turn affixed the reed pan 26, into the reed cavity 20, through a channel 21 and either directly into the atmosphere 23 or first through a resonating chamber 24 and then into the atmosphere. In the instance where air passes directly into the atmosphere, the passage, particularly of lower pitch notes, may be enlarged to act as a resonating chamber 22. The direction of air flow is out (from mouth to instrument). Additionally, a second set of reeds may be included to allow their sounding when drawing air into the mouth from the instrument. In this case, reed flaps (valves) like those found in harmonicas and accordions may be used to prevent the reeds for the opposite direction of air flow from sounding.

In the configuration where the invention takes the form of an electronic, digital, synthesizer, MIDI, and/or software emulated instrument, the note being played is determined by sensing what button (the word button is used interchangeably with key here) is pressed. The volume and other characteristics of the notes are determined from the characteristics of the key-strike and/or via a breath pressure sensor. Both in and out breath can be detected so as to allow the musician to continue playing whether breathing in or out.

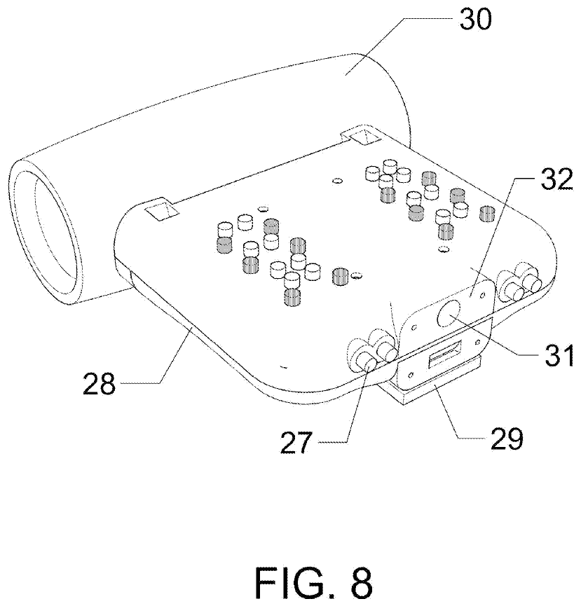

In addition to existing functions, inputs, and outputs on electronic/digital/synthesizer/MIDI/software instruments, the current invention also may have transpose buttons that can transpose notes played by one octave increments (applied to buttons for either hand or both hands), allowing the musician to switch between bass, tenor, alto, soprano, and other versions of the instrument quickly. These buttons 27 may be conveniently located for the thumbs to reach (FIG. 8) and may be activated momentarily only while the button is pressed or toggle when the button is pressed. Additionally, there may be buttons to cause simultaneously played notes to sound as strummed notes rather than simultaneous notes and breath control lockouts so that the instrument can be played without the use of the breath.

The electronic version of the invention may take a modular form (FIG. 8). In this form, the central portion 28 of the instrument includes the buttons and computer for sensing their activation and sending a MIDI signal to an external synthesizer. A small computer such as that of a smart phone 29 can be attached by mounts to the instrument to function as a synthesizer (via apps like Garageband) and send the sound produced to an external speaker. Additionally, a speaker 30 can be attached to the instrument so that the instrument can function as a standalone electronic wind instrument. Just as with the acoustic version of the invention, the electronic instrument can be played with a mouthpiece or blow hose (attaches via mouthpiece hole 31) or the neck (attaches via neck attachment region 32) and possibly a mouthpiece attaching to the neck. It can also be played with no breath apparatus at all (volume locked). All of these variations may be joined in any combination to create a multitude of possible permutations as in a modular system.

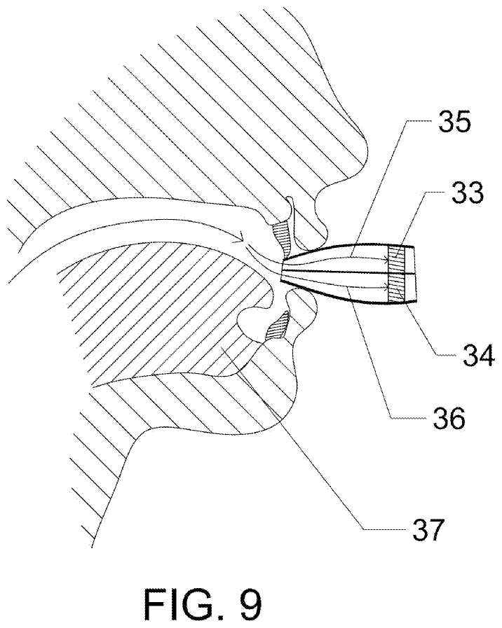

The electronic version of the invention may also incorporate a novel breath control sensor (FIG. 9) that makes use of two separate pressure sensors 33, 34 to detect differing air flows 35, 36 as directed by the tongue 37 into channels. As the tongue rises, less air pressure is delivered to the lower sensor and this difference can be used to instruct the instrument to raise or lower the pitch of the note(s) being played. In this way, more expression can be used when playing, such as pitch bends and vibrato (oscillating of pitch). Alternatively, the difference in pressure between the upper and lower sensor may be used to determine whether to strum notes in an upwards or downwards direction as puffs of air are delivered. In addition to the configuration where the breath sensors are stacked vertically, they may alternatively be positioned side by side such that control is achieved by moving the tongue from side to side.

1-20. (canceled)

21. A musical instrument comprising a polyphonic keyboard wherein the keyboard has at least two parallel sequential rows of keys with the closest adjacent keys between the parallel sequential rows corresponding with musical notes one octave apart by pitch.

22. A musical instrument as in claim 21 wherein the musical instrument is a free reed wind instrument.

23. A musical instrument comprising a polyphonic keyboard wherein the keyboard has one sequential row of keys segmented into at least two groups of keys.

24. A musical instrument as in claim 23 wherein the musical instrument is a free reed wind instrument.

25. A musical instrument comprising a polyphonic keyboard wherein the keyboard has at least two parallel sequential rows of keys with the closest adjacent keys between the sequential parallel rows corresponding with musical notes one octave apart by pitch and the keyboard is segmented into at least two groups of keys.

26. A musical instrument as in claim 25 wherein the musical instrument is a free reed wind instrument.

27. A musical instrument as in claim 25 wherein any two of the adjacent groups of keys together span a musical alphabet including sharps and flats with one of the groups of keys spanning the first half of the musical alphabet starting on any letter, approximately, and the other group of keys spanning the remaining half of the musical alphabet, approximately.

28. A musical instrument as in claim 25 further comprising additional redundant keys for Unproved fingering.

29. A musical instrument as in claim 25 wherein the groups of keys are positioned side-by-side.

30. A musical instrument as in claim 25 wherein there are two parallel rows of keys per group and the parallel sequential rows of keys within each group are mirror images of each other.

31. A musical instrument as in claim 25 wherein the keys that are for natural musical notes do not physically overlap the keys that are for sharp/flat musical notes.

32. A musical instrument as in claim 25 further comprising a body that is sufficiently small so as to be handheld.

33. A musical instrument as in claim 25 further comprising a mouthpiece.

34. A musical instrument as in claim 25 further comprising a neck.

35. A musical instrument as in claim 25 further comprising a hose.

36. A musical instrument as in claim 26 further comprising:
an opening into which air is blown;
a chamber wherein air blown into the opening results in pressurizing of the chamber;
a plurality of free reeds that vibrate to produce sound;
a plurality of channels through which air exits the chamber when the keys are pressed wherein the pressurized air sounds at least one of the plurality of free reeds corresponding to the keys pressed;
at least one reed plate to which the plurality of free reeds are attached;
a reed pan containing the channels and to which the chamber, the at least one reed plate, and the keys are attached.

37. A musical instrument as in claim 36 further comprising:
an additional plurality of free reeds wherein individual additional free reeds sound when air is drawn out of the opening and the corresponding key is pressed;
a plurality of flaps wherein individual flaps prevent air from traveling past free reeds in the unintended direction of air travel.

38. A musical instrument as in claim 26 further comprising at least one microphone for the purposes of amplifying the sound produced by the instrument.

39. A musical instrument as in claim 25 further comprising:
an opening into which air is blown;
at least one breath sensor for detecting the characteristics of air blown into the opening;
a plurality of key sensors for detecting the pressing of keys;
a system for gathering data from the at least one breath sensor and plurality of key sensors and outputting the resulting notes and intended sound characteristics.

40. A musical instrument as in claim 39 further comprising;
a mouthpiece with at least two separate air channels, each of which leads to a breath sensor;
a system that receives the breath sensors' outputs and, depending on their differences, determines the pitch of the notes to be sounded.
